(19) United States
(12) Patent Application Publication
(10) Pub. No.: US 2025/0259327 A1
(43) Pub. Date: Aug. 14, 2025

(54) ELECTRONIC DEVICE, INFORMATION CONVERSION METHOD, AND METHOD FOR TRAINING NEURAL NETWORK MODEL BY USING TRAINING DATA GENERATED BY INFORMATION CONVERSION METHOD

(71) Applicant: SK TELECOM CO., LTD., Seoul (KR)

(72) Inventor: Seongsoo LEE, Seoul (KR)

(21) Appl. No.: 19/191,400

(22) Filed: Apr. 28, 2025

Related U.S. Application Data
(63) Continuation of application No. PCT/KR2024/002020, filed on Feb. 13, 2024.

(30) Foreign Application Priority Data
Feb. 10, 2023 (KR) 10-2023-0018293

(51) Int. Cl. G06T 7/70; G06N 3/08; G06T 7/20; G06T 7/62; G06V 10/60; G06V 10/774

(52) U.S. Cl. CPC G06T 7/70; G06N 3/08; G06T 7/20; G06T 7/62; G06V 10/60; G06V 10/774; G06T 2207/30241

(57) ABSTRACT

Disclosed is an information conversion method performed by an electronic device. The method comprises the steps of: obtaining a relative coordinate system-based movement trajectory and the relative coordinate system-based radio environment information; obtaining absolute coordinate system data of a point of interest corresponding to the relative coordinate system-based movement trajectory; and converting the relative coordinate system-based radio environment information into absolute coordinate system-based radio environment information by using the absolute coordinate system data of the point of interest.

### CROSS-REFERENCE TO RELATED APPLICATIONS

This application is a Continuation of International Patent Application No. PCT/KR2024/002020, filed on Feb. 13, 2024, which claims the benefit of priority to Korean Patent Application No. 10-2023-0018293, filed on Feb. 10, 2023, the entire contents of which are incorporated herein by reference.

### TECHNICAL FIELD

The present invention relates to an electronic device and an information conversion method performed by the electronic device.

### BACKGROUND ART

Among positioning methods based on a radio environment, a fingerprinting positioning method is a pattern recognition technology that measures wireless received signal strength at several reference positions known in advance to generate a radio environment map and then determines, as a positioning position, a reference position with the most similar signal strength characteristics in a radio environment map with respect to a strength of a signal received at a positioning position. The fingerprinting positioning method achieves higher accuracy as an interval between the reference positions becomes smaller, and also achieves higher accuracy as the number of wireless signal transmission sources increases.

However, in wireless signal shadow areas, the radio environment map may not be generated or the reliability of the generated radio environment map may not be high, which leads to difficulties in positioning.

Recently, the positioning performance has also been improved through deep learning techniques that train an artificial neural network model with training data composed of global positioning system (GPS) information and radio environment information as an absolute coordinate system, and derive positioning results using the pre-trained artificial neural network model.

However, in GPS shadow areas such as underground shopping malls, wireless signals may be received from indoor wireless APs, but GPS information, i.e., absolute coordinate system information, may not be received, which leads to difficulties in collecting training data to be used for training the artificial neural network model.

### DETAILED DESCRIPTION OF INVENTION

### Technical Problem

According to an embodiment, the present invention provides an electronic device for converting relative coordinate system-based radio environment information, which can be obtained without being restricted by location constraints such as GPS shadow areas, into absolute coordinate system-based radio environment information, and an information conversion method.

However, the problem to be solved by the present disclosure is not limited to that mentioned above, and other problems to be solved that are not mentioned may be clearly understood by those of ordinary skill in the art to which the present disclosure belongs from the following description.

### Technical Solution

In accordance with a first aspect of a method for converting information, performed by an electronic device, the method comprising: obtaining a relative coordinate system-based movement trajectory and the relative coordinate system-based radio environment information; obtaining absolute coordinate system data of a point of interest corresponding to the relative coordinate system-based movement trajectory; and converting the relative coordinate system-based radio environment information into absolute coordinate system-based radio environment information by using the absolute coordinate system data of the point of interest.

In accordance with a second aspect of an electronic device, comprising: a memory storing one or more instructions; and a processor executing the one or more instructions stored in the memory, wherein the one or more instructions, when executed by the processor, cause the processor to: obtain a relative coordinate system-based movement trajectory and the relative coordinate system-based radio environment information; obtain absolute coordinate system data of a point of interest corresponding to the relative coordinate system-based movement trajectory; and convert the relative coordinate system-based radio environment information into absolute coordinate system-based radio environment information by using the absolute coordinate system data of the point of interest.

In accordance with a third aspect of the present disclosure, there is provided a non-transitory computer-readable storage medium storing a computer program, wherein the computer program, when executed by a processor, comprises an instruction for causing the processor to obtain a relative coordinate system-based movement trajectory and the relative coordinate system-based radio environment information; obtain absolute coordinate system data of a point of interest corresponding to the relative coordinate system-based movement trajectory; and convert the relative coordinate system-based radio environment information into absolute coordinate system-based radio environment information by using the absolute coordinate system data of the point of interest.

In accordance with a fourth aspect of a method for training a neural network model by an electronic device, the method comprising: preparing training data that includes training input data including radio environment information of a predetermined position and training label data including absolute coordinate system data of a point of interest corresponding to the predetermined position; and training the neural network model to output absolute coordinate system data of the point of interest corresponding to the radio environment information by using the training data.

### Effect of the Invention

According to an embodiment, relative coordinate system-based radio environment information that can be obtained without being restricted by a location such as a GPS shadow area is converted into absolute coordinate system-based radio environment information. As a result, it is possible to collect training data that can be used for training for positioning of an artificial neural network model without being restricted by a location such as a GPS shadow area.

In addition, by using a point of interest obtained by using a movement trajectory of a camera and a captured image for coordinate system conversion, it is possible to versatility for utilizing devices that can be easily obtained in the surroundings such as a smartphone equipped with a camera.

In addition, by extracting coordinate information on an absolute coordinate system for an object in the image captured by the camera from an electronic map that can be considered as verified data used for navigation, etc., it is possible to easily obtain the previously verified coordinate information.

### DESCRIPTION OF DRAWINGS

FIG. 1 is a configuration diagram of a radio environment-based positioning system to which an information conversion method according to an embodiment of the present invention may be applied.

FIG. 2 is a block diagram of an electronic device that functions as a client device or a server device in the radio environment-based positioning system of FIG. 1 and is capable of performing an information conversion method according to an embodiment of the present invention.

FIGS. 3 to 5 are flowcharts for describing the information conversion method according to an embodiment of the present invention.

FIG. 6 is an exemplar diagram of the relative coordinate system-based movement trajectory that may be obtained in the radio environment-based positioning system of FIG. 1.

FIG. 7 illustrates an embodiment of converting the relative coordinate system-based movement trajectory into the absolute coordinate system-based movement trajectory in the radio environment-based positioning system of FIG. 1

FIG. 8 illustrates an embodiment of determining the positioning positions when managing the training data for each set space in the radio environment-based positioning system of FIG. 1

### MODE FOR DISCLOSURE

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding invention. Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

In addition, a term such as a “unit” or a “portion” used in the specification means a software component or a hardware component such as FPGA or ASIC, and the “unit” or the “portion” performs a certain role. However, the “unit” or the “portion” is not limited to software or hardware. The “portion” or the “unit” may be configured to be in an addressable storage medium, or may be configured to reproduce one or more processors. Thus, as an example, the “unit” or the “portion” includes components (such as software components, object-oriented software components, class components, and task components), processes, functions, properties, procedures, subroutines, segments of program code, drivers, firmware, microcode, circuits, data, database, data structures, tables, arrays, and variables. The functions provided in the components and “unit” may be combined into a smaller number of components and “units” or may be further divided into additional components and “units”.

Hereinafter, the embodiment of the present disclosure will be described in detail with reference to the accompanying drawings so that those of ordinary skill in the art may easily implement the present disclosure. In the drawings, portions not related to the description are omitted in order to clearly describe the present disclosure.

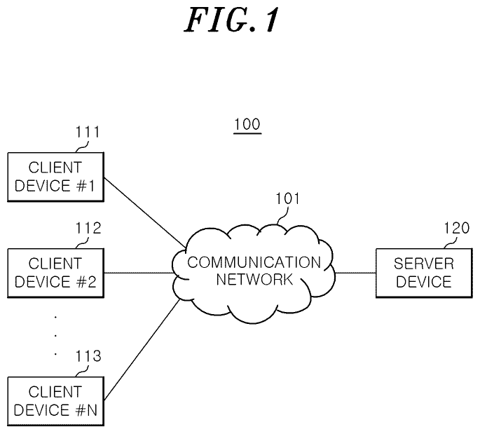

FIG. 1 is a configuration diagram of a radio environment-based positioning system to which an information conversion method according to an embodiment of the present invention may be applied.

The radio environment-based positioning system 100 may be connected to at least one client device 111, 112, and 113 and a server device 120 through a communication network 101.

The client devices 111, 112, and 113 may obtain relative coordinate system-based movement trajectory and radio environment information, and provide the obtained relative coordinate system-based movement trajectory and radio environment information to the server device 120 through the communication network 101. Here, the relative coordinate system may be a coordinate system that is arbitrarily set according to a criterion set in advance initially. For example, the relative coordinate system may be a coordinate system in which a front direction of a camera is set as the Z axis, a downward direction of the camera is set as a Y axis, a right direction of the camera is set as an X axis, and an initial position is set as the origin. In addition, the relative coordinate system-based movement trajectory may be a movement trajectory of the camera mounted on the client devices 111, 112, and 113, and the client devices 111, 112, and 113 may provide images captured by the camera within the relative coordinate system-based movement trajectory to the server device 120 through the communication network 101. In addition, the client devices 111, 112, and 113 may provide GPS information together to the server device 120.

The server device 120 may receive and obtain the relative coordinate system-based movement trajectory and the radio environment information from at least one client device 111, 112, and 113 through the communication network 101. The server device 120 may obtain absolute coordinate system data of a point of interest related to the relative coordinate system-based movement trajectory, and convert the relative coordinate system-based radio environment information into absolute coordinate system-based radio environment information using the absolute coordinate system data of the point of interest. Here, the point of interest may be a position of an object included in the image captured by the camera within the relative coordinate system-based movement trajectory, and may be at least three locations. For example, the object whose position may be the point of interest may be an object (e.g., a signboard, etc.) that includes a name of the point of interest. In addition, when the server device 120 obtains the absolute coordinate system data of the point of interest, the server device 120 may recognize names of the objects within the images captured by the camera, and extract coordinate information on an absolute coordinate system corresponding to the recognized names from an electronic map. Here, when the names of the objects included in the images captured within the relative coordinate system-based movement trajectory are recognized multiple times, if the same name is recognized, only an object with the largest size among the objects may be determined to be valid.

In addition, the server device 120 may generate absolute coordinate system position information of a point of interest related to the relative coordinate system-based movement trajectory and radio environment information of the corresponding position as training data. In addition, the server device 120 may train an artificial neural network model to generate a positioning map based on the radio environment information by using the training data generated through the above-described operation. Here, the training data may exist for each of a plurality of set spaces, and when the server device 120 generates the training data, the server device may generate the training data based on outdoor positioning information (e.g., GPS data) of the client devices 111, 112, and 113 corresponding to one of the plurality of set spaces. For example, the client devices 111, 112, and 113 further include an outdoor positioning confirmation module capable of confirming outdoor positioning information (e.g., GPS data) and may periodically confirm the outdoor positioning information (e.g., GPS data). When the client devices 111, 112, and 113 enter a shadow area or enter an inside of a building, the outdoor positioning information (e.g., GPS data) may not be detected by the outdoor positioning confirmation module. Accordingly, the client devices 111, 112, and 113 may confirm an identifier of the shadow area existing within a predetermined range, an identifier of a building existing within the corresponding range, etc., based on the finally confirmed outdoor positioning information (e.g., GPS data), and determine one of a plurality of set spaces by selecting one of the confirmed identifier of the shadow area or the identifier of the building.

Referring to the radio environment-based positioning system 100 of FIG. 1, an embodiment has been described in which the client devices 111, 112, and 113 provide the relative coordinate system-based movement trajectory and the radio environment information to the server device 120, and the server device 120 performs information conversion processing. In contrast, another embodiment may be performed in which the client devices 111, 112, and 113 directly perform the information conversion processing based on the relative coordinate system-based movement trajectory and the radio environment information that the client devices 111, 112, and 113 themselves have obtained. These two embodiments differ only in a subject of the information conversion processing, but the information conversion process and principle are the same or similar, which will be described again below.

The client devices 111, 112, and 113 and/or the server device 120 constituting the radio environment-based positioning system 100 of FIG. 1 may be implemented by an electronic device capable of a computing operation. For example, the electronic device may include a mobile communication terminal, also called a smartphone, including a camera, a GPS receiver, a communication module, etc. In addition, the electronic device may include a desktop PC, a notebook PC, a tablet PC, etc.

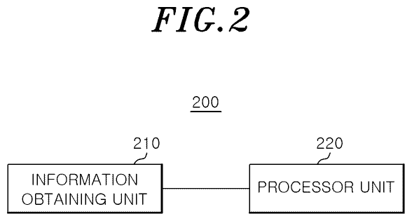

As illustrated in FIG. 2, an electronic device 200 may include an information obtaining unit 210 and a processor unit 220. In addition, the electronic device 200 may further include a display unit (not illustrated) for providing a processing result by the processor unit 220. In addition, the electronic device may further include a communication unit (not illustrated) capable of transmitting processing result data by the processor unit 220 to an external device. In addition, the electronic device 200 may further include a memory (not illustrated) in which information related to various functions or instructions may be stored. For example, the memory may include a hard disk, an SSD, a flash memory, etc., in addition to a ROM and a RAM. The processor unit 220 may include one or more processors. For example, one or more processors may be a general-purpose processor such as a central process unit (CPU) and a digital signal processor (DSP), or an artificial intelligence-only processor such as a neural process unit (NPU).

In the above description, referring to FIG. 1, an embodiment has been described in which the client device 111, 112, and 113 provides the relative coordinate system-based movement trajectory and the radio environment information to the server device 120 and the server device 120 performs the information conversion processing, and another embodiment has been described in which the client devices 111, 112, and 113 directly performs the information conversion processing based on the relative coordinate system-based movement trajectory and the radio environment information that the client devices 111, 112, and 113 themselves has obtained.

In both an embodiment and another embodiment, the information obtaining unit 210 may obtain the relative coordinate system-based movement trajectory and the radio environment information. Here, the relative coordinate system-based movement trajectory may be the relative coordinate system-based movement trajectory of the camera included in the information obtaining unit 210, and the information obtaining unit 210 may obtain the image captured by the camera within the relative coordinate system-based movement trajectory of the electronic device 200. For example, the radio environment information may be a received strength of a signal transmitted from a mobile communication repeater and/or a wireless access point (AP) installed in the vicinity. In addition, the information obtaining unit 210 may obtain GPS information. In addition, the information obtaining unit 210 may directly measure and/or receive the relative coordinate system-based movement trajectory, the radio environment information, the GPS information, etc., or may receive the measured and/or set coordinate system-based movement trajectory, radio environment information, GPS information, etc., from communication devices in the vicinity.

In an embodiment, the electronic device 200 functioning as the client devices 111, 112, and 113 may further include a communication unit, and the communication unit may provide various types of information obtained by the information obtaining unit 210 to the server device 120 through the communication network 101 under the control of the processor unit 220.

In an embodiment, the electronic device 200 functioning as the client devices 111, 112, and 113 may further include the communication unit, and the communication unit may receive and obtain various types of information obtained by the client devices 111, 112, and 113 through the communication network 101 under the control of the processor unit 220.

In the embodiment of the present disclosure, the information obtaining unit 210 is disclosed as a separate component distinct from the processor unit 220, but the present disclosure is not limited thereto and may be changed and applied in various ways. For example, an operation performed by the information obtaining unit 210, that is, an operation of obtaining the relative coordinate system-based movement trajectory and the radio environment information may be performed by the processor unit 220.

In both an embodiment and another embodiment, the processor unit 220 may obtain the absolute coordinate system data of the point of interest related to the relative coordinate system-based movement trajectory, and convert the relative coordinate system-based radio environment information into the absolute coordinate system-based radio environment information using the absolute coordinate system data of the point of interest. Here, the point of interest may be the position of the object included in the image captured by the camera within the relative coordinate system-based movement trajectory, and may be at least three locations. For example, the object whose position may be the point of interest may be the object (e.g., a signboard, etc.) that includes the name of the point of interest.

In addition, when the processor unit 220 obtains the absolute coordinate system data of the point of interest, the processor unit 220 may recognize the name of the object within the image captured by the camera, and extract the coordinate information on the absolute coordinate system corresponding to the recognized name from the electronic map. Here, when the names of the objects included in the images captured within the relative coordinate system-based movement trajectory are recognized multiple times, if the same name is recognized, only the object with the largest size among the objects may be determined to be valid.

In addition, the processor unit 220 may generate the absolute coordinate system position information of the point of interest related to the relative coordinate system-based movement trajectory and the radio environment information of the corresponding position as the training data. In addition, the processor unit 220 may train the artificial neural network model to generate the positioning map based on the radio environment information by using the training data generated by the above-described operation. Here, the training data may exist for each of the plurality of set spaces, and when the processor unit 220 generates the training data, the processor unit 220 may generate the training data based on the GPS data of the client devices 111, 112, and 113 corresponding to one of the plurality of set spaces. Here, one of the plurality of set spaces may be a space determined by the identifier of the shadow area or the identifier of the building described above.

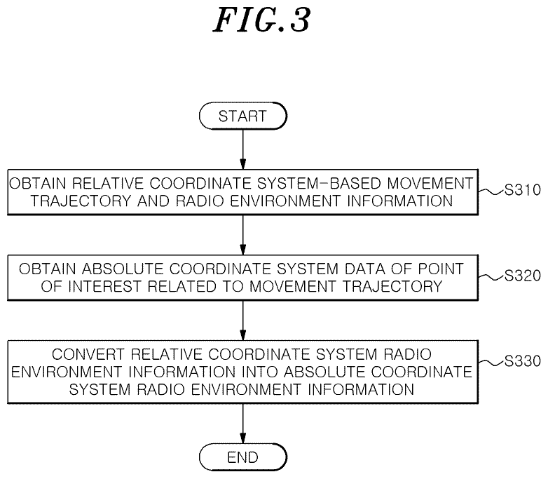

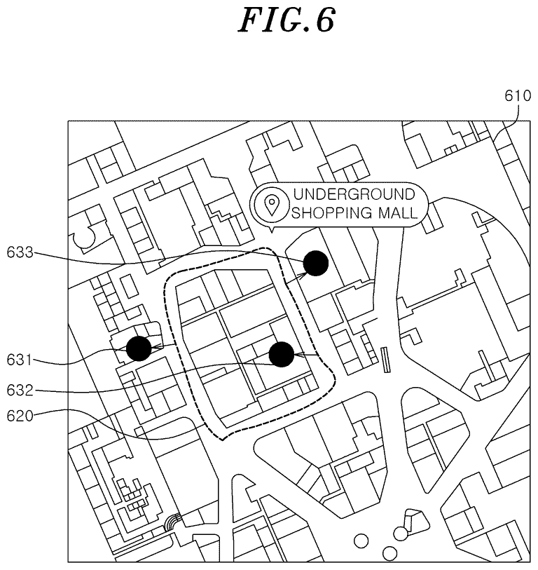

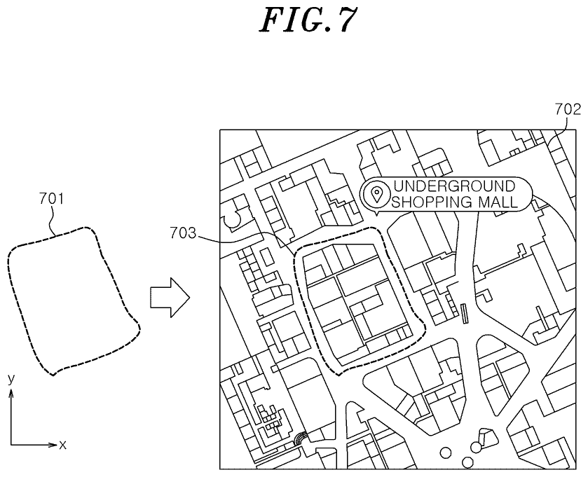

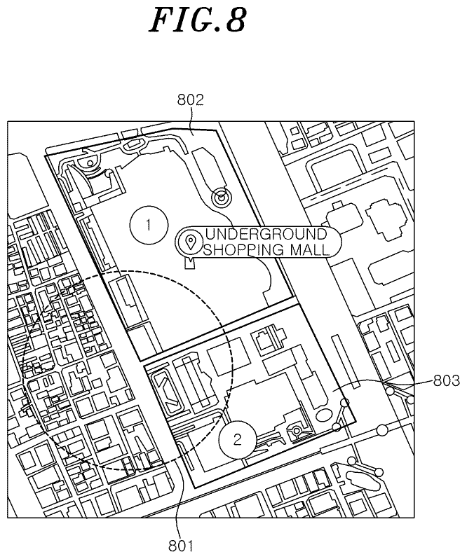

FIGS. 3 to 5 are flowcharts for describing the information conversion method according to an embodiment of the present invention, FIG. 6 is an exemplar diagram of the relative coordinate system-based movement trajectory that may be obtained in the radio environment-based positioning system of FIG. 1, FIG. 7 illustrates an embodiment of converting the relative coordinate system-based movement trajectory into the absolute coordinate system-based movement trajectory in the radio environment-based positioning system of FIG. 1, and FIG. 8 illustrates an embodiment of determining the positioning positions when managing the training data for each set space in the radio environment-based positioning system of FIG. 1.

Hereinafter, the information conversion method performed by the electronic device 200 that may function as the client devices 111, 112, and 113 or the server device 120 will be described with reference to FIGS. 1 to 8.

The radio environment-based positioning measures wireless received signal strength at several reference positions known in advance to generate a radio environment map and then determines, as a positioning position, a reference position with the most similar signal strength characteristics in a radio environment map with respect to a strength of a signal received at a positioning position. In addition, in order to improve positioning performance through a deep learning technique that derives positioning results using an artificial neural network model, the training data composed of the GPS information and the radio environment information as the absolute coordinate system should be collected, and the collected training data should be trained in advance for the artificial neural network model. However, in a GPS shadow area such as an “underground shopping mall” as exemplified in FIG. 6, the GPS information, i.e., the absolute coordinate system information, may not be received, so it is difficult to collect the training data to be used for training the artificial neural network model. This difficulty may be overcome by converting the relative coordinate system-based radio environment information pre-configured in the electronic device 200 functioning as the client devices 111, 112, and 113 into the absolute coordinate system-based radio environment information, and generating the training data using the converted absolute coordinate system-based radio environment information.

Referring to FIG. 3, the information obtaining unit 210 of the electronic device 200 functioning as the client devices 111, 112, and 113 obtains the relative coordinate system-based movement trajectory and the radio environment information in the GPS shadow area such as the “underground shopping mall” as exemplified in FIG. 6. Here, the relative coordinate system-based movement trajectory may be the relative coordinate system-based movement trajectory of the camera mounted on the client devices 111, 112, and 113, and the client devices 111, 112, and 113 may be the image captured by the camera within the relative coordinate system-based movement trajectory (S310).

In an embodiment where the client devices 111, 112, and 113 themselves performs the information conversion processing, the client device 111, 112, and 113 may perform processing on the information obtained in step S310, and in an embodiment where the server device 120 performs the information conversion processing, the server device 120 may provide the information obtained in step S310 to the server device 120 through communication network 101.

Thereafter, the information conversion processing is performed by the client devices 111, 112, and 113 or the server device 120, and the information conversion processing is performed by the processor unit 220 of the electronic device 200 that functions as the client devices 111, 112, and 113 or the server device 120 that is the subject of the information conversion processing.

For the information conversion processing, the processor unit 220 of the electronic device 200 first obtains the absolute coordinate system data of the point of interest related to the relative coordinate system-based movement trajectory (S320).

Here, the point of interest may be the position of the object included in the image captured by the camera within the relative coordinate system-based movement trajectory, and may be at least three locations. For example, the object whose position may be the point of interest may be the object (e.g., a signboard, etc.) that includes the name of the point of interest.

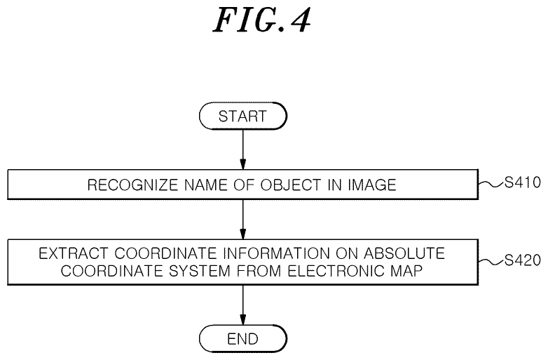

Referring to FIG. 4, various stores may be located in the “underground shopping mall” exemplified in FIG. 6, and these stores may have signs with their names, such as their shop names, installed outside. The processor unit 220 may recognize names of objects 631, 632, and 633 within the surrounding images captured by the camera while moving along the relative coordinate system-based movement trajectory 620. In this way, since the processor unit 220 recognizes the names of the objects 631, 632, and 633 within the images is a well-known technical concept, a detailed description thereof will be omitted. Here, when the processor unit 220 recognizes the names of the objects 631, 632, and 633 included in the images captured within the relative coordinate system-based movement trajectory multiple times multiple times, if the same name is recognized, only the object with the largest size among the objects 631, 632, and 633 may be determined to be valid. For example, in the case where the same signboard is recognized multiple times, since an object and name recognized within an image captured at the closest distance are more reliable than other recognition results, only the case where the size of the recognized object is the largest is determined to be valid, thereby preventing the points of interest from being duplicated (S410). In this way, when the names of the objects 631, 632, and 633 are recognized, the processor unit 220 may obtain the coordinate information on the absolute coordinate system corresponding to the recognized name from the electronic map 610 as the absolute coordinate system data of the point of interest related to the relative coordinate system-based movement trajectory. Here, the electronic map 610 may be stored in a separate electronic map device or may be pre-stored in a memory (not illustrated) constituting the electronic device 200 (S420).

Referring back to FIG. 3, the processor unit 220 converts the relative coordinate system-based radio environment information into the absolute coordinate system-based radio environment information by using the absolute coordinate system data of the point of interest related to the relative coordinate system-based movement trajectory obtained through step S320.

In the “underground shopping mall” exemplified in FIG. 6, when the coordinate information on the absolute coordinate system for three or more points of interest, i.e., the objects 631, 632, and 633 in the vicinity of the relative coordinate system-based movement trajectory 620 is known, a movement trajectory 701 on the relative coordinate system may be converted into a movement trajectory 703 on the absolute coordinate system by using a rotation/translation transformation matrix of Equation 1 as exemplified in FIG. 7. Reference numeral 702 in FIG. 7 is an example of an electronic map 702 that may be used for navigation, etc., and this electronic map 702 includes the coordinate information on an absolute coordinate system for various points of interest.

$${( R , t )}^{*} = arg {min}_{R , t} {\sum }_{i = 1}^{n} {( {Rp}_{j} + t - {q}_{i} )}^{2} \qquad [ Equation 1 ]$$

Here, R and t denote the rotation/translation matrix for conversion to the absolute coordinate system, pᵢ denotes a position of an i-th keyframe where a name is recognized, and qᵢ denotes position information of the point of interest where the name is recognized in the i-th keyframe. Since Equation 1 is non-linear, non-linear optimization may be performed using gauss-newton, levenberg-marquardt optimization, etc.

In the “underground shopping mall” exemplified in FIG. 6, among the objects 631, 632, and 633, the objects 631 and 632 are biased to the left of the camera position, i.e., the relative coordinate system-based movement trajectory 620, and the object 633 is biased to the right of the camera position, i.e., the relative coordinate system-based movement trajectory 620. In this case, when the relative coordinate system movement trajectory 701 is converted into the absolute coordinate system as illustrated in FIG. 7 by using the rotation/translation transformation matrix obtained through Equation 2, the relative coordinate system-based movement trajectory 703 may be slightly biased to the left. These errors decrease as the number of corresponding points of interest in the relative coordinate system movement trajectory increases. The reason is that, when there are the points of interest that are evenly matched rather than a specific position during the relative coordinate system-based movement trajectory of the camera, the probability of not being biased in a specific direction increases, and when obtaining the rotation/translation transformation matrix through Equation 1, these errors cancel each other out.

By converting the relative coordinate system-based movement trajectory 701 on the relative coordinate system into the relative coordinate system-based movement trajectory 703 on the absolute coordinate system in this way, the processor unit 220 may also convert the radio environment information corresponding to the relative coordinate system-based movement trajectory 701 on the relative coordinate system into the radio environment information corresponding to the relative coordinate system-based movement trajectory 703 on the absolute coordinate system (S330).

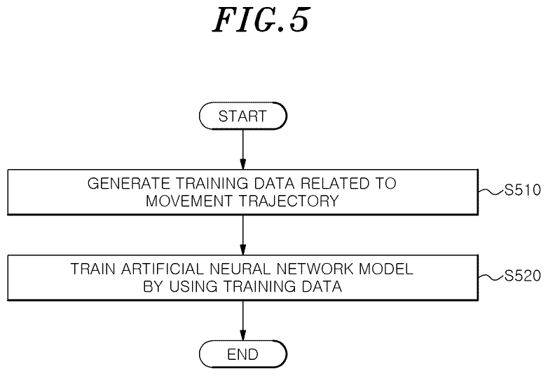

In addition, referring to FIG. 5, the processor unit 220 may generate the absolute coordinate system position information of the point of interest related to the relative coordinate system-based movement trajectory and the radio environment information of the corresponding position as the training data in the state in which the absolute coordinate system-based radio environment information is secured (S510), and may train the artificial neural network model using the training data so as to generate the positioning map based on the radio environment information (S520).

As illustrated in FIG. 8, multiple underground shopping malls may be located in a city. In other words, the GPS shadow area may exist in multiple locations. Therefore, the training data for training the artificial neural network model may exist for each of the plurality of set spaces. In this case, when the processor unit 220 generates the training data, the processor unit 220 may generate the training data based on the GPS data of the client devices 111, 112, and 113 corresponding to one of the plurality of set spaces. For example, when the client devices 111, 112, and 113 enter the shadow area or enter the inside (or basement) of the building, the outdoor positioning information (e.g., GPS data) may not be detected by the outdoor positioning confirmation module.

Accordingly, the processor unit 220 may select an identifier of underground shopping mall1 802 and an identifier of underground shopping mall2 803 as candidates based on valid GPS information 801 before the electronic device 200 enters the GPS shadow area. In addition to the position information, the GPS information includes horizontal dilution of precision (HDOP) information that indicates reliability, which is a value meaning a “degree to which position precision of horizontal coordinates interferes”, and the smaller the value, the higher the accuracy of the position coordinates. For example, when the HDOP is about 2.5 or less, it may be determined that the GPS information is valid.

The processor unit 220 may display candidate positions on a display unit (not illustrated), and then generate the training data corresponding to either the identifier of underground shopping mall1 802 or the identifier of underground shopping mall2 803 according to the input selection information. Alternatively, the processor unit 220 may generate the training data by automatically selecting a location where the object with the corresponding name, that is, the point of interest, is positioned among the underground shopping mall1 802 and the underground shopping mall2 803 based on the results of recognizing the name of the object in the image described with reference to FIG. 4. For example, when a location with a larger number of matching points of interest among underground shopping mall1 802 and underground shopping mall2 803 is finally selected to generate the training data, errors may be minimized even if some points of interest with the same name exist in duplicate.

As described above, according to an embodiment of the present invention, relative coordinate system-based radio environment information that can be obtained without being restricted by a location such as a GPS shadow area is converted into absolute coordinate system-based radio environment information. As a result, it is possible to collect training data that can be used for training for positioning of an artificial neural network model without being restricted by a location such as a GPS shadow area.

In addition, by using a point of interest obtained by using a movement trajectory of a camera and a captured image for coordinate system conversion, it is possible to versatility for utilizing devices that can be easily obtained in the surroundings such as a smartphone equipped with a camera.

In addition, by extracting coordinate information on an absolute coordinate system for an object in the image captured by the camera from an electronic map that can be considered as verified data used for navigation, etc., it is possible to easily obtain the previously verified coordinate information.

Meanwhile, a computer program may be implemented to include instructions for causing a processor to perform each step included in the information conversion method performed by the electronic device according to the above-described embodiment.

In addition, the computer program including the instructions for causing the processor to perform each step included in the information conversion method performed by the electronic device according to the above-described embodiment may be recorded on a computer-readable recording medium.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

1. A method for converting information, performed by an electronic device, the method comprising:
obtaining a relative coordinate system-based movement trajectory and the relative coordinate system-based radio environment information;
obtaining absolute coordinate system data of a point of interest corresponding to the relative coordinate system-based movement trajectory; and
converting the relative coordinate system-based radio environment information into absolute coordinate system-based radio environment information by using the absolute coordinate system data of the point of interest.

2. The method of claim 1, wherein the relative coordinate system-based movement trajectory is a movement trajectory of a camera, and
the point of interest is a position of an object included in an image captured by the camera within the relative coordinate system-based movement trajectory.

3. The method of claim 2, wherein the captured image within the relative coordinate system-based movement trajectory includes information indicating a name of the point of interest, and
the obtaining of the absolute coordinate system data includes:
recognizing the name of the point of interest from the captured image within the relative coordinate system-based movement trajectory; and
extracting coordinate information on an absolute coordinate system corresponding to the recognized name from an electronic map.

4. The method of claim 2, wherein the captured image within the relative coordinate system-based movement trajectory includes information indicating a name of the point of interest, and
the obtaining of the absolute coordinate system data includes:
recognizing names of the points of interest from each of a plurality of images captured within the relative coordinate system-based movement trajectory; and
determining the absolute coordinate system data based on sizes of objects included in the plurality of images when there is an identical name among the names of the points of interest recognized from the plurality of images.

5. The method of claim 4, wherein the determining of the absolute coordinate system data based on the sizes of the objects included in the plurality of images includes:
selecting an image including an object having a largest size among the plurality of images; and
verifying the absolute coordinate system data corresponding to the selected image.

6. The method of claim 1, further comprising generating training data that includes training label data including absolute coordinate system position information of the point of interest corresponding to the relative coordinate system-based movement trajectory and training input data including radio environment information of a position corresponding to the absolute coordinate system position information of the point of interest.

7. The method of claim 1, further comprising:
verifying outdoor positioning information from an outdoor positioning confirmation module equipped in the electronic device; and
determining an area for obtaining the relative coordinate system-based movement trajectory and the radio environment information based on the outdoor positioning information.

8. The method of claim 7, wherein the determining of the area for obtaining the relative coordinate system-based movement trajectory and the radio environment information includes:
verifying an identifier of a shadow area or an identifier of a building existing within a predetermined range based on the outdoor positioning information; and
selecting one of the identifier of the shadow area or the identifier of the building existing within the confirmed predetermined range.

9. The method of claim 8, wherein the selecting of one of the identifier of the shadow area or the identifier of the building existing within the confirmed predetermined range includes:
providing the confirmed identifier of the shadow area or the confirmed identifier of the building to a user; and
determining one of the identifier of the shadow area or the identifier of the building based on information input by the user.

10. The method of claim 8, wherein the selecting of one of the identifier of the shadow area or the identifier of the building existing within the confirmed predetermined range includes determining an identifier of a nearest shadow area or an identifier of a nearest building based on the outdoor positioning information.

11. The method of claim 7, further comprising generating training data that includes training label data including information identifying the determined area and absolute coordinate system position information of the point of interest corresponding to the relative coordinate system-based movement trajectory, and training input data including radio environment information of a position corresponding to the absolute coordinate system position information of the point of interest.

12. An electronic device, comprising:
a memory storing one or more instructions; and
a processor executing the one or more instructions stored in the memory,
wherein the one or more instructions, when executed by the processor, cause the processor to:
obtain a relative coordinate system-based movement trajectory and the relative coordinate system-based radio environment information;
obtain absolute coordinate system data of a point of interest corresponding to the relative coordinate system-based movement trajectory; and
convert the relative coordinate system-based radio environment information into absolute coordinate system-based radio environment information by using the absolute coordinate system data of the point of interest.

13. The electronic device of claim 12, wherein the relative coordinate system-based movement trajectory is a movement trajectory of a camera, and
the point of interest is a position of an object included in an image captured by the camera within the relative coordinate system-based movement trajectory.

14. The electronic device of claim 13, wherein the captured image within the relative coordinate system-based movement trajectory includes information indicating a name of the point of interest, and
wherein the one or more instructions, when executed by the processor, further cause the processor to:
recognize the name of the point of interest from the captured image within the relative coordinate system-based movement trajectory; and
extract coordinate information on an absolute coordinate system corresponding to the recognized name from an electronic map.

15. The electronic device of claim 12, wherein the one or more instructions, when executed by the processor, further cause the processor to:
generate training data that includes training label data including absolute coordinate system position information of the point of interest corresponding to the relative coordinate system-based movement trajectory and training input data including radio environment information of a position corresponding to the absolute coordinate system position information of the point of interest.

16. A method for training a neural network model by an electronic device, the method comprising:
preparing training data that includes training input data including radio environment information of a predetermined position and training label data including absolute coordinate system data of a point of interest corresponding to the predetermined position; and
training the neural network model to output absolute coordinate system data of the point of interest corresponding to the radio environment information by using the training data.

17. The method of claim 16, wherein the training label data further includes one identifier selected from among an identifier of a shadow area or an identifier of a building existing within a predetermined range, and
the training of the neural network model is trained to further output one identifier selected from among the identifier of the shadow area or the identifier of the building existing within the predetermined range.
